(19) United States
(12) Patent Application Publication
(10) Pub. No.: US 2021/0332553 A1
(43) Pub. Date: Oct. 28, 2021

(54) TRENCHING CHAINSAW BLADE DEVICE

(71) Applicant: Tyler Graetz, Grand Forks, ND (US)

(72) Inventor: Tyler Graetz, Grand Forks, ND (US)

(21) Appl. No.: 16/858,582

(22) Filed: Apr. 25, 2020

(51) Int. Cl. E02F 5/06

(52) U.S. Cl. CPC E02F 5/06

(57) ABSTRACT

A trenching chainsaw blade including a digger chain including a right side and a left side, each side is a mirror image of each other and each side is mounted in an alternating fashion to a right side and a left side of the digger chain respectively, each side including a plurality of sets of teeth and connecting links, wherein each set of teeth includes a scooped blade trenching tooth and a non-scooped blade tooth separated by at least one connecting link.

### FIELD OF THE INVENTION

Embodiments described herein generally relate to a chainsaw blade, and more particularly to a trenching chainsaw blade.

### BACKGROUND OF THE INVENTION

Digging trenches is a major component of residential and commercial construction, functioning for most as a method of protecting easily damaged infrastructure or utilities, such as, gas mains, water mains, etc. However, trenching can be extremely difficult using traditional tools, especially if the sediment in the desired area is extremely compact. The inability to effectively dig trenches may result in reduced utility services in a given area. Hence, an effective tool for easily digging trenches is desirable.

### BRIEF DESCRIPTION OF THE DRAWINGS

The various advantages of the embodiments of the present disclosure will become apparent to one skilled in the art by reading the following specification and appended claims, and by referencing the following drawing(s), in which:

FIG. 1 shows an exemplary view of a trenching chainsaw blade device according to an embodiment of the present disclosure.

FIG. 2 shows an exemplary view of a digging chain of the trenching chainsaw blade device according to an embodiment of the present disclosure.

FIG. 3 shows an exemplary sectional view of the digging chain of the trenching chainsaw blade device according to an embodiment of the present disclosure.

### SUMMARY OF THE INVENTION

Exemplary embodiments disclosed herein describe a trenching chainsaw blade including a digger chain including a right side and a left side, each side is a mirror image of each other and each side is mounted in an alternating fashion to a right side and a left side of the digger chain respectively, each side including a plurality of sets of teeth and connecting links, wherein each set of teeth includes a scooped blade trenching tooth and a non-scooped blade tooth separated by at least one connecting link.

In some exemplary embodiments, the device of claim 1, wherein the scooped blade trenching tooth and the non-scooped blade tooth both include carbon tips.

In some exemplary embodiments, each set of teeth further includes a driver part.

In some exemplary embodiments, each tooth includes a top surface and a bottom surface.

In some exemplary embodiments, the driver part is located at the bottom surface of each tooth for pushing a corresponding top surface blade tooth into the ground.

In some exemplary embodiments, the scooped blade trenching tooth is located on the top surface of the tooth for removing debris while digging into a ground surface.

In some exemplary embodiments, the non-scooped blade tooth is located on the top surface of the tooth for digging into a ground surface.

In some exemplary embodiments, the digger chain is attached to a guide bar of a chainsaw.

### DETAILED DESCRIPTION

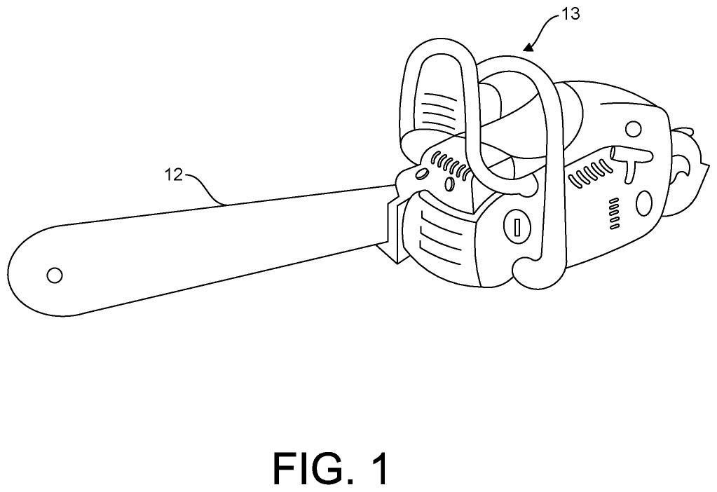

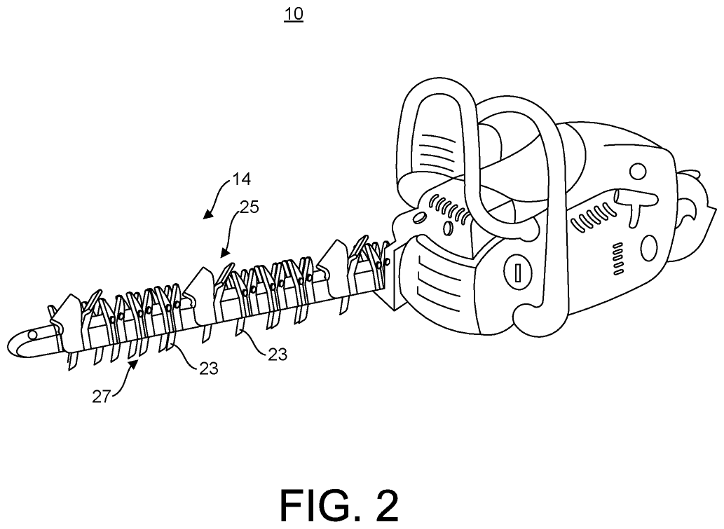

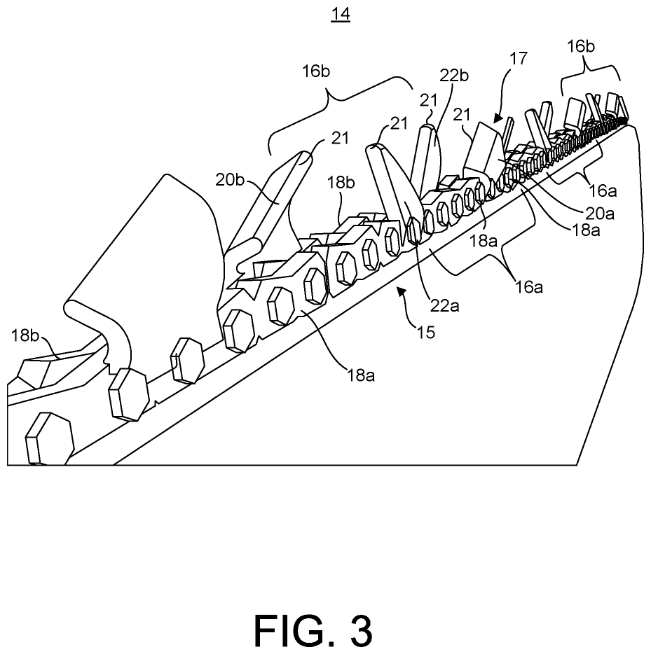

The present disclosure relates to a trenching chainsaw blade device (“the device”). The device allows persons to dig trenches in an uncomplicated manner. As illustrated in FIGS. 1-3, the device 10 includes a chainsaw 13 including a guide bar 12 and a digging chain 14. The digging chain 14 attaches to the edge of the guide bar 12 forming a loop. The digging chain 14 includes a right side 15 and a left side 17. Each side is a mirror image of each other and each side is mounted in an alternating fashion to a corresponding right side and left side of the digger chain respectively.

Moreover, the right side 15 and the left side 17 of the digging chain 14 each include a plurality of sets of teeth (i.e., 16a, 16b) and a plurality of connecting links (i.e., 18a, 18b). Each set of teeth includes a scooped blade trenching tooth (i.e., 20a, 20b) and a non-scooped blade tooth (i.e., 22a, 22b) which may be separated by at least one connecting link. Each tooth (i.e., scooped blade trenching tooth and non-scooped blade tooth) includes a carbon tip 21 and a driver part 23. The carbon tips allow the teeth to be highly durable. The driver part 23 pushes a corresponding blade tooth into the ground. In addition, each tooth has a top surface 25 and a bottom surface 27. The scooped blade trenching tooth 20 is located on the top surface of a corresponding tooth and operates to remove debris while digging into a ground surface. The non-scooped blade tooth 22 is located on the top surface of a corresponding tooth and operates to dig into a ground surface. The driver part 23 is located on a bottom surface of each tooth and, as noted, the driver part operates to push the corresponding blade tooth on the top surface of the tooth into the ground.

In operation, the chainsaw 13 is manually supported by a cross bar handle and manually propelled through the ground by a crouching operation with the digging chain and guide bar directed downwardly to a desired depth while the digging chain delivers excavated ground parts to the surface.

Moreover, it should be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A trenching chainsaw blade device:
a digger chain including a right side and a left side, each side is a mirror image of each other and each side is mounted in an alternating fashion to a right side and a left side of the digger chain respectively, each side including a plurality of sets of teeth and connecting links, wherein each set of teeth includes a scooped blade trenching tooth and a non-scooped blade tooth separated by at least one connecting link.

2. The device of claim 1, wherein the scooped blade trenching tooth and the non-scooped blade tooth both include carbon tips.

3. The device of claim 1, wherein each set of teeth further includes a driver part.

4. The device of claim 3, wherein each tooth includes a top surface and a bottom surface.

5. The device of claim 4, wherein the driver part is located at the bottom surface of each tooth for pushing a corresponding top surface blade tooth into the ground.

6. The device of claim 4, wherein the scooped blade trenching tooth is located on the top surface of the tooth for removing debris while digging into a ground surface.

7. The device of claim 4, wherein the non-scooped blade tooth is located on the top surface of the tooth for digging into a ground surface.

8. The device of claim 1, wherein the digger chain is attached to a guide bar of a chainsaw.
